(19) United States
(12) Patent Application Publication
(10) Pub. No.: US 2009/0149242 A1
(43) Pub. Date: Jun. 11, 2009

(54) GAMING DEVICE WITH CONFIGURABLE REEL LIGHTING

(75) Inventors: Mark Woodard, Reno, NV (US); Gene Powell, Reno, NV (US); Steve McGahn, Reno, NV (US)

Correspondence Address: Armstrong Teasdale LLP (IGT - 26668);Robert B. Reeser, III, One Metropolitan Square, Suite 2600, St. Louis, MO, 63102, US

(73) Assignee: IGT, A NEVADA CORPORATION, Reno, NV (US)

(21) Appl. No.: 11/952,264

(22) Filed: Dec. 7, 2007

(51) Int. Cl. G07F 17/34

(52) U.S. Cl. 463/21

(57) ABSTRACT

Provided in embodiments of the present invention is a configurable reel lighting apparatus for gaming devices. In one embodiment, a gaming device having a plurality of spinnable reels includes a molded frame visually separating the reels and having a plurality of openings. The gaming device also includes a plurality of individual light sources corresponding to at least a portion of the plurality of openings, where each light source is associated with one of the plurality of spinnable reels.

### FIELD OF THE INVENTION

The present invention relates generally a gaming device with configurable reel lighting, and more particularly to an electronic spinning-reel gaming device having reel lighting including individual reel lights that are configurable in illuminating individual reels.

### BACKGROUND

Although gaming has existed in some form for many years, its present familiar form of slot devices, table games, sports books, etc. has mainly developed in the last few decades. In gaming devices such as conventional slot machines, three or more spinnable reels are often used to display gaming outcomes to a player. Generally, only a portion of each reel is visible to the player. Additionally, one or more paylines are displayed across the visible portion of the reels, where symbols lining up along one or more of these paylines results in an award. To initiate play of these conventional slot machines, a player places a wager and pulls a gaming handle or presses one or more buttons to set the reels in motion. The reels typically stop one by one and any award resulting from specific symbols landing on a payline is credited or payed out to the player.

To better display the reels, conventional gaming devices often include one or more lights located above and/or below the reels to illuminate the reels and make the symbols more visible to players. In some conventional slot machines, a single florescent light is provided above the reels and a single florescent light is provided below the reels to help illuminate the reels. Other conventional slot machines have included reel lights to backlight certain positions on the reels, such as winning symbols along a payline. However, these typical reel lighting configurations provide little flexibility in lighting the reels to highlight or emphasize events occurring during game play.

These and other problems in conventional gaming devices are addressed by embodiments of the present invention.

### SUMMARY

Embodiments of the present invention provide configurable reel lighting for gaming devices. In one embodiment, a gaming device having a plurality of spinnable reels includes a molded frame visually separating the reels and having a plurality of openings. The gaining device also includes a plurality of individual light sources corresponding to at least a portion of the plurality of openings, where each light source is associated with one of the plurality of spinnable reels.

### BRIEF DESCRIPTION OF THE DRAWINGS

FIG. 1A illustrates a schematic view of a gaming device according to an embodiment of the present invention.

FIG. 1B illustrates an isometric view of the gaming device illustrated in FIG. 1A.

FIG. 2 illustrates an isometric view of a gaming door according to an embodiment of the present invention.

FIG. 3 illustrates a schematic view a gaming device according to an embodiment of the present invention.

FIG. 4A illustrates a side view of a gaming device according to an embodiment of the present invention.

FIG. 4B illustrates a side view of the gaming device shown in FIG. 4A with a gaming door in a closed position.

FIG. 4C illustrates a detailed view of section A of the gaming device shown in FIGS. 4A and 4B.

FIG. 5A illustrates an isometric view of a molded frame according to an embodiment of the present invention.

FIG. 5B illustrates an isometric view of a molded frame according to another embodiment of the present invention.

FIG. 6 illustrates a front view of a reel glass according to an embodiment of the present invention.

### DETAILED DESCRIPTION

To address the problems discussed above and other problems, embodiments of the present invention are directed to gaming device having reel lighting including individual reel lights that are configurable in illuminating individual reels. Some of these embodiments are described below in detail, and in addition, some specific details are shown for purposes of illustrating the inventive principles. However, numerous other arrangements may be devised in accordance with the inventive principles of this patent disclosure. Thus, while the present invention is described in conjunction with the specific embodiments illustrated in the drawings, it is not limited to these embodiments or drawings. Rather, it is intended to cover alternatives, modifications, and equivalents that come within the scope and spirit of the inventive principles set out in the appended claims. Further, well known processes have not been described in detail in order not to obscure the present invention. Thus, the inventive principles are not limited to the specific details disclosed herein.

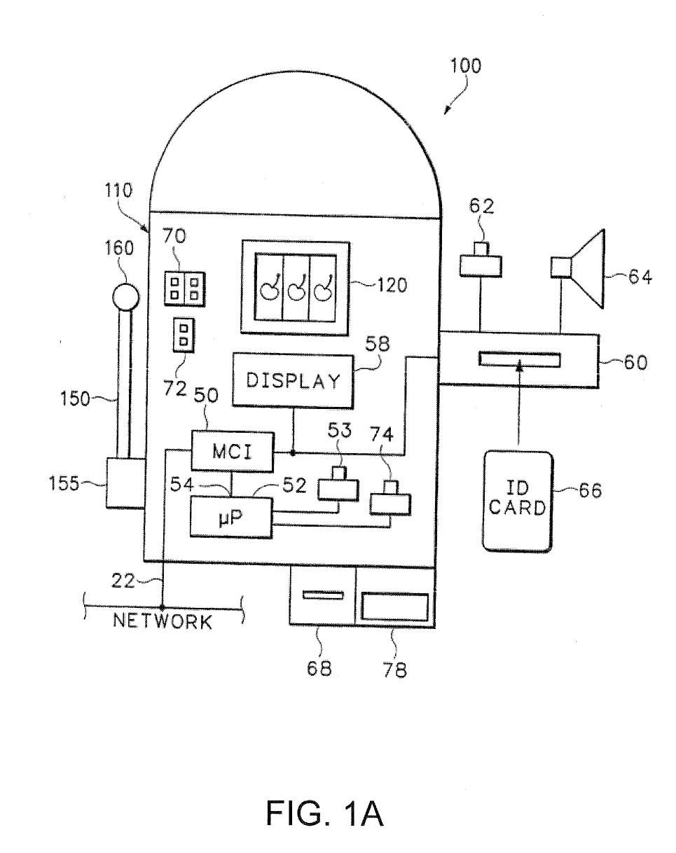

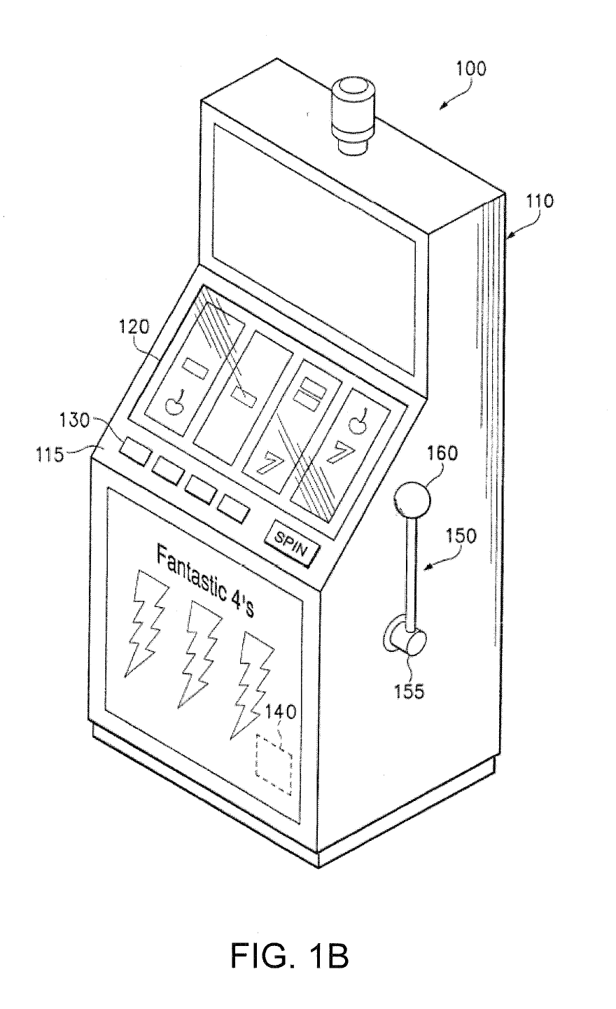

FIGS. 1A and 1B illustrate a gaming device according to an embodiment of the present invention. FIG. 1A is a schematic view of the gaming device and FIG. 1B is an isometric view of the gaming device.

Referring to FIGS. 1A and 1B, the gaming device 100 shown in this embodiment is an electro-mechanical slot machine. That is, the gaming device 100 is a spinning reel type slot machine, where the reels are driven by mechanical means, such as stepper motors (not shown), but are actually controlled by electronic circuitry housed in the gaming device 100. Although the embodiment shown in FIGS. 1A and 1B includes such a electro-mechanical slot machine, other embodiments of the present invention may include various non-spinning reel type gaming devices, such as video slot machines, computer based gaming machines, wireless gaming devices, multi-player gaming stations, modified personal electronic gaming devices, and the like.

Returning to the embodiment shown in FIGS. 1A and 1B, the gaming device 100 includes a gaming cabinet 110 that houses various components of the gaming device 100. The gaming cabinet 110 may include a display area 120 that displays the result of a gaming session and a player interface area 115 or panel that includes one or more buttons for game play. The gaming device 100 also includes a gaming handle 150 that is coupled to the gaming cabinet 110 by way of a coupler 155.

The gaming device 100 may be connected to a gaming server or other gaming devices (see FIG. 7 for example) through a gaming network 22 that connects to the gaming device 100 through a machine communication interface (MCI) 50 housed in the gaming cabinet 110. The MCI 50 may facilitate communication between the network 22 and processor 52, which controls the operation of the gaming device 100. This communication may occur via a serial port 54 on the processor to which the MCI 50 is connected.

Also included in the gaming device 100 is a display area 120 that may include three to five spinning reels. Note that while the schematic view (FIG. 1) generally represents the display area 120 as having three spinning reels, the isometric view of the gaming device 100 in FIG. 1B shows the gaming machine 100 having a display area 120 including four reels. Each reel includes a plurality of different symbols thereon. These reels may spin in response to a gaming session being initiated in response to, for example, a pull on a gaming handle 150 or actuation of a spin button 53 after a wager is made. One or all of the reels in display area 120 may include a special bonus initiator symbol which, when obtained on the gaming machine's payline, will cause the MCI 50 to initiate the secondary bonus game.

The MCI 50 may also include a random access memory (RAM), which can be used to store gaming information, such as storing total coin-in statistics about a present gaming session. The MCI may also facilitate communication between the network 22 and a vacuum florescent display (VFD) 58, a card reader 60, a player-actuated push button 62, and a speaker 64.

During typical play on a slot machine, like gaming device 100, a player plays by placing a wager and then initiating a gaming session by pulling the gaming handle 51 or depressing the spin button 53. The wager may be placed, for example, by inserting a bill into a bill acceptor 68. The gaming device 100 may also include a coin acceptor (not shown) that may also be used by the player to make a wager. A credit meter 70 is a numeric display that indicates the total number of credits available for the player to wager. The credits are in the base denomination of the machine. For example, in a nickel slot machine, when a five-dollar bill is inserted into bill acceptor 68, a credit of “100” appears on credit meter 70. To place a wager, the player can generally depress a coin-in button (one of the buttons on the player interface panel 115, such as 130), which transfers a credit from the credit meter 70 to a coin-in meter 72. Each time the button is depressed a single credit transfers to the coin-in meter up to a maximum bet that can be placed on a single play of the machine. In addition, a maximum-bet button (another button on the player interface panel 115, such as 130) may be provided to immediately transfer the maximum number of credits that can be wagered on a single play from the credit meter 70 to the coin-in meter 72, and may further initiate the gaming session by spinning the reels. Otherwise when the coin-in meter 72 reflects the number of credits that the player intends to wager, the player can initiate the gaming session by pulling the gaming handle 150 or depressing the spin button 53.

The player may choose to have any jackpot won applied to credit meter 70. When the player wishes to cash out, the player depresses a cash-out button (another button on the player interface panel 115, such as 130), which causes the credits on meter 70 to be paid out to the player in the form of a ticket (which can later be cashed in or inserted into another gaming device) through ticket printer 78, or may be paid out in the form of returning coins to the player at a hopper (not shown). The machine consequently pays to the player the number of credits—in the base denomination of the machine—that appear on credit meter 70.

Card reader 60 may read a player-tracking device, such as a player tracking card 66 that is issued by the casino to individual players who choose to have such a card. Card reader 60 and player-tracking card 66 are known in the art, as are player-tracking systems. Briefly summarizing such a system, a player registers with the casino prior to commencing gaming. The casino issues a unique player-tracking card to the player and opens a corresponding player account that is stored on a server or host computer (see, for example, FIG. 7). The player account may include the player's name and mailing address and perhaps other information of interest to the casino in connection with marketing efforts. Prior to playing one of the gaming devices in the casino, the player inserts the player tracking card 66 into the player tracking reader 60 thus permitting the casino to track player activity, such as amounts wagered, credits won, and rate of play.

To induce the player to use the card, the casino may award each player points proportional to the money wagered by the player. Players consequently accrue points at a rate related to the amount wagered. The points may be displayed on display 58. In conventional player tracking systems, the player may take his or her card to a special desk in the casino where a casino employee scans the card to determine how many accrued points are in the player's account. The player may then redeem points for selected merchandise, meals in casino restaurants, or the like, which each have assigned point values.

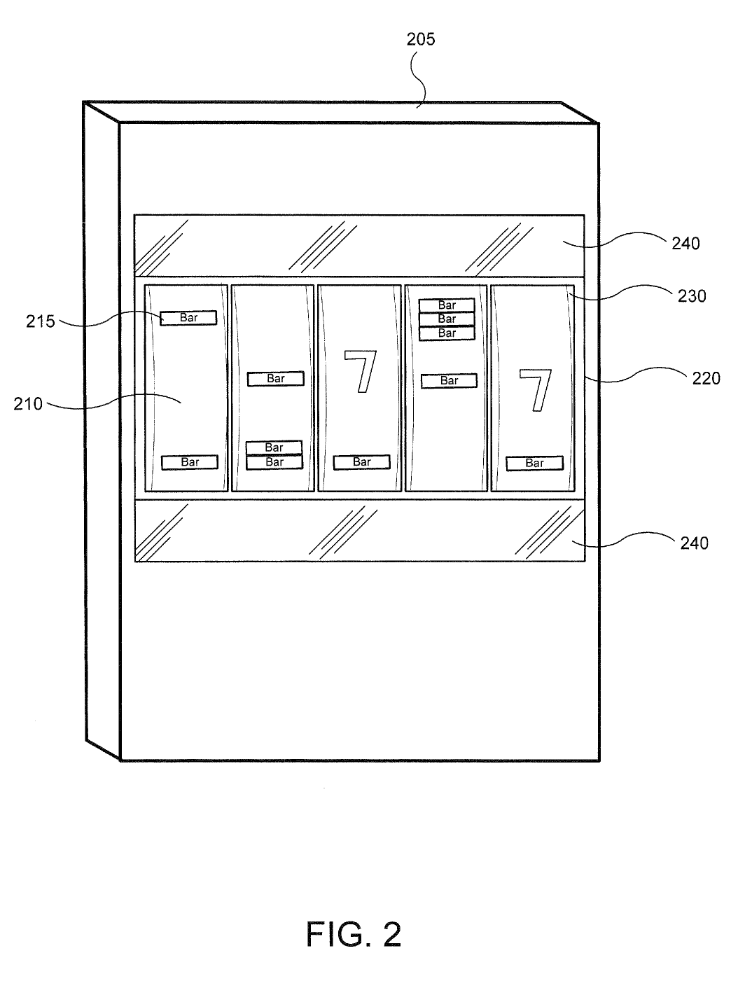

FIG. 2 illustrates an isometric view of a gaming door according to an embodiment of the present invention. The gaming door shown in FIG. 2 is shown with limited details of gaming controls or other displays that may be present to emphasize features of this embodiment. Referring to FIG. 2, the gaming door 205 of a gaming device includes five spinning reels 210. Each of the spinning reels 210 is partially visible to a player through reel glass 220. Typically three to nine reel stop positions 215 of each spinning reel 210 are visible to a player, although more or fewer visible reel stop positions 215 may be visible depending upon the layout of the reels and the game design. The reel glass 220 may include substantially transparent portions 230 that correspond to the portions of the spinning reels 210 that are to be visible to the player. The reel glass 220 may also include partially opaque portions 240 that display illuminated colors and/or designs. These partially opaque portions 240 may have fluorescent backlighting to display the colors and designs printed on the reel glass. In other embodiments, however, these portions may have a specially etched light reflective acrylic sheet included behind the reel glass that displays the colors and designs via edge lighting. An example of the etched acrylic sheet is the light panel manufactured by the Hunatech Corporation. These sheets are typically brighter and more energy efficient than backlighting designs. In these embodiments, the reel glass itself in portions 240 may be transparent with the etched light reflective acrylic sheet providing the substantial opaqueness.

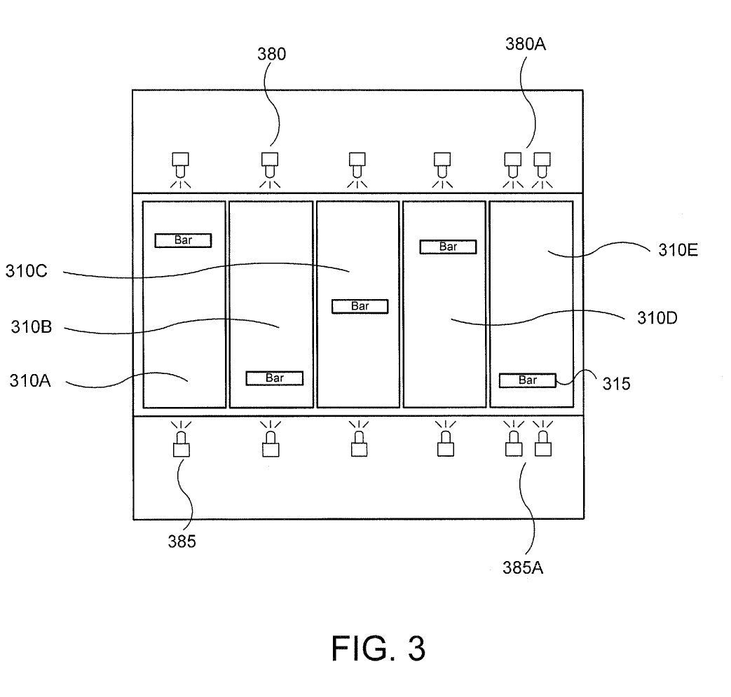

FIG. 3 illustrates a schematic view a gaming device according to an embodiment of the present invention. Referring to FIG. 3, individual reel light sources 380, 380A, 385, and 385A are shown above and below the visible portions of the spinning reels 310A, 310B, 310C, 310D, and 310E. The individual light sources 380, 380A, 385, and 385A may include LEDs (light emitting diodes), fluorescent lights, incandescent lights, neon lights, or other known light sources. In some embodiments, LEDs are preferred because they have a relatively long burn life, they require relatively low power, and they are easy to quickly turn on and off. In addition, LEDs are available in many different colors and can be mounted to existing light board designs for gaming devices. The individual light sources 380, 380A, 385, and 385A may include multicolor LEDs that can be instructed to illuminate in a plurality of colors. In some embodiments, only the individual reel light sources 380 located above the visible portions of the spinning reels 310 may be included. Likewise, in other embodiments only the individual reel light sources 385 located below the visible portions of the spinning reels 310 may be included. However, since the spinning reels 310 are curved toward the reel glass, it may be preferable to include both the upper and lower individual reel light sources 380 and 385 to completely illuminate the visible portion of the spinning reels 310.

As mentioned above, these individual reel light sources 380, 380A, 385, and 385A may be implemented to highlight particular combinations of reel stops 315 that land on a payline or on the visible portion of the spinning reels 310. For example, if a reel stop 315 represented by a bar lands on a center payline on the first spinning reel 310A, the individual reel light sources 380 and/or 385 that correspond to the first spinning reel 310A may illuminate the first spinning reel 310A in a particular color or manner. This illumination scheme may include illuminating the designated spinning reel in a specific color, illuminating the designated spinning reel with a flashing light, or otherwise illuminating the designated reel to draw attention to that spinning reel. It may be desirable to illuminate the spinning reels to highlight wins, highlight favorable reel stop symbols 315 appearing on a payline or visible area, or highlight a bonus round.

In the embodiment shown in FIG. 3, the first, second, third, and fourth spinning reels 310A, 310B, 310C, and 310D are each illuminated above and below by single individual reel light sources 380 and 385. The fifth spinning reel 310E is illuminated above and below by pairs of individual reel light sources 380A and 385A. A single individual light source 380, 385 may be preferably used where only a single color is desired or may be used with a multicolored LED. Multiple individual light sources 380A, 385A may be preferably used where multiple colors are desired using multiple single color LEDs or where extra illumination is required. In the embodiment shown in FIG. 3, the fifth spinning reel 310E may have two individual reel light sources 380A, 385A above and below its visible portion to show a different color when a fifth reel stop symbol 315 appears on a payline (giving the player a five symbol win) versus when the fifth spinning reel 310E does not display the fifth reel stop symbol 315 needed for a five symbol win. For example, when a the first through fourth spinning reels display a “BAR” reel stop symbol 315 on a payline where each spinning reel is illuminated by a bright white color from the individual reel light sources 380, 385 as the spinning reels 310 come to a stop with the “BAR” symbol 315 on the payline, the fifth spinning reel 310E may illuminate with a bright white light from the individual reel light sources 380A and 385A if a fifth “BAR” symbol 315 lands on the payline, or the fifth spinning reel 310E may illuminate with a bright red light from the from the individual reel light sources 380A and 385A if a fifth “BAR” symbol 315 does not land on the payline.

In other similar embodiments, the fifth spinning reel 310E may simply be illuminated with extra light sources when the fifth “BAR” symbol 315 lands on the payline giving the player a five symbol pay to extenuate the win. In other embodiments, each spinning reel 310 may have multiple light sources 380A, 385A above and below the visible portions of the spinning reels 310. This configuration may allow for greater flexibility in illuminating the spinning reels 310 to highlight wins, positive symbol hits, or bonus rounds. Alternatively, single light sources 380, 385 may be associated above and below the visible portion of the spinning reels 310.

There are numerous circumstances in which individual reel illumination may build excitement or anticipation in a player during the play of a gaming device. While all of these circumstances or configurations of using the individual reel light sources 380, 380A, 385, and 385A to illuminate the spinning reels 310 are not described in detail, they are contemplated and fall within the scope of the present invention.

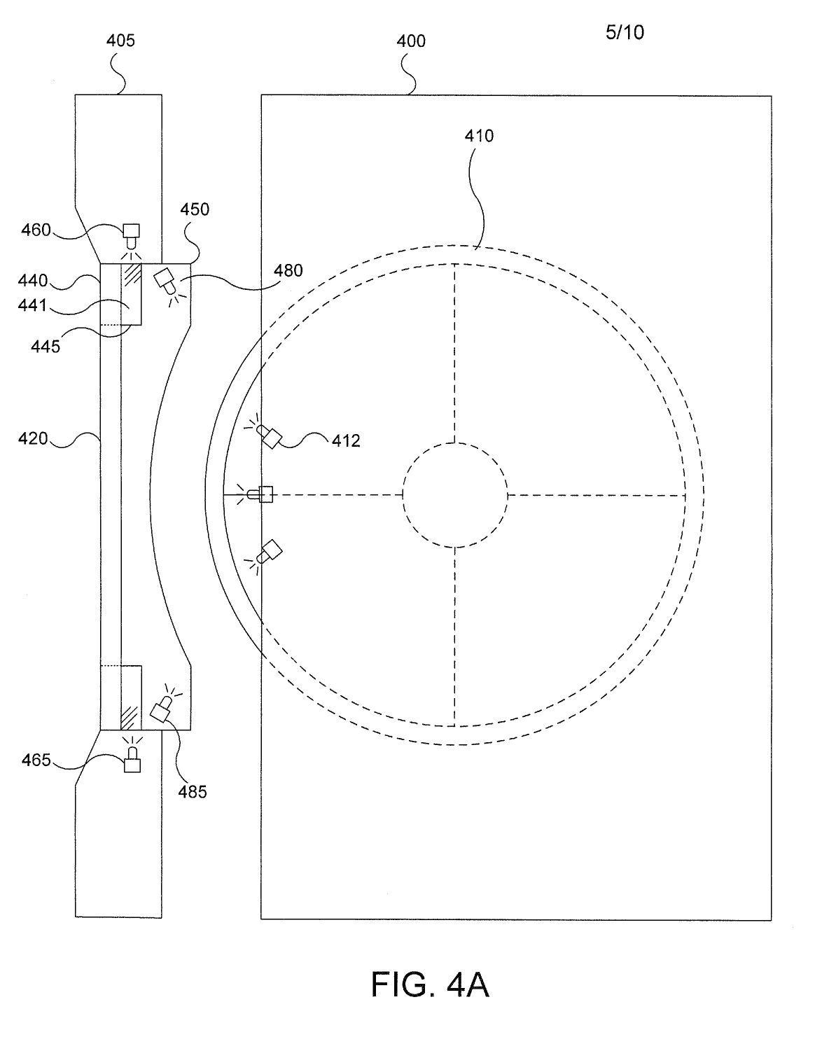

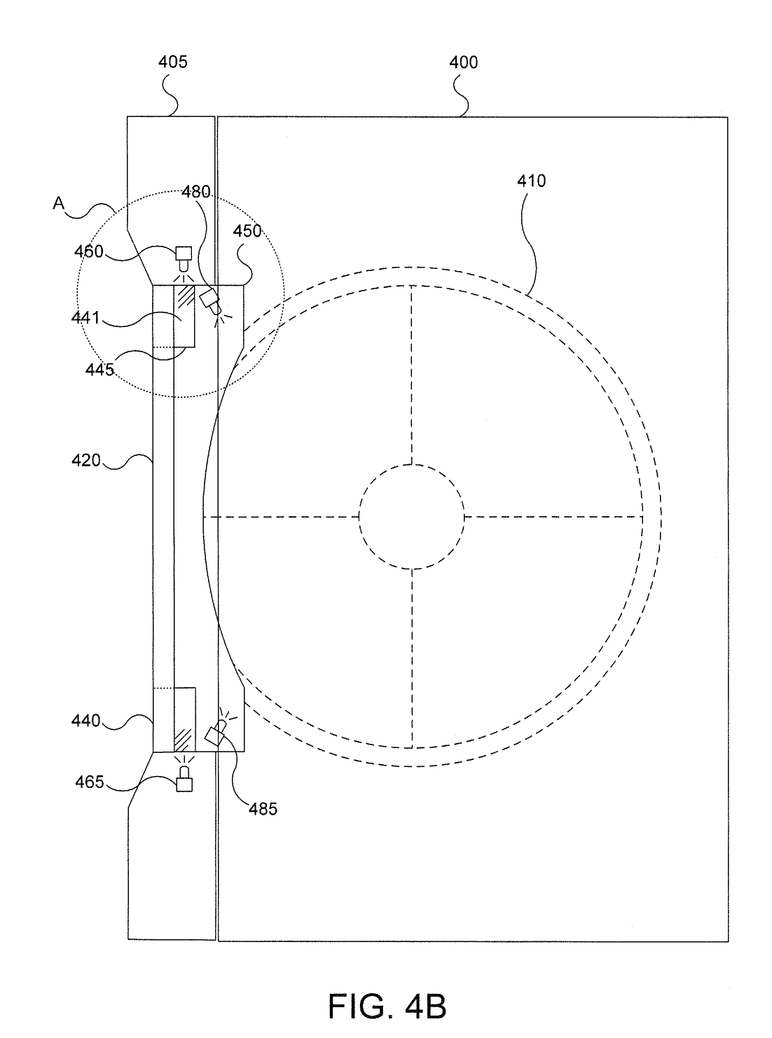

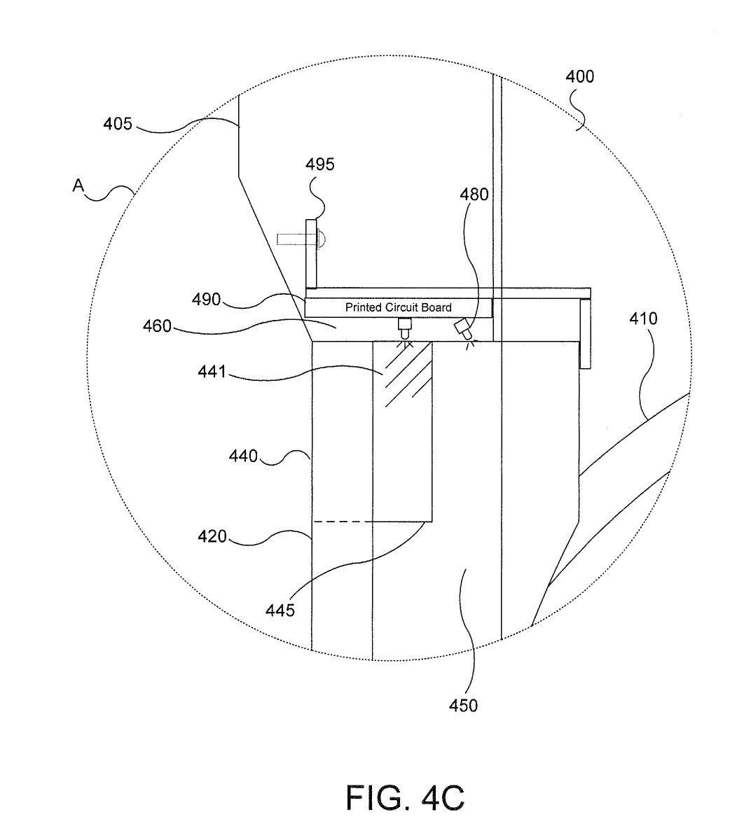

FIG. 4A illustrates a side view of a gaming device according to an embodiment of the present invention. Referring to FIG. 4A, a gaming device 400 includes a plurality of spinning reels 410. The gaming device 400 may also include one or more reel back lights 412. Reel back lights 412 may illuminate a particular symbol on the reel strips when it lands in a desired position. As there are typically at least three positions of reel stops that are visible and in play for multi-line games, three reel back lights 412 may be positioned for each of the spinning reels 410 to illuminate a symbol in any of the reel stop positions that are in play. These reel back lights 412 may be used in conjunction with the individual reel light sources 480 and 485 or may be omitted.

A main gaming device door 405 may include reel glass 420 that includes substantially transparent portions to display portions of the spinning reels 410 and portions that are substantially opaque as described with reference to FIG. 2. These substantially opaque portions 440 may be opaque due to etched light panels 441 (also referred to as Hunatech panels) placed directly behind them. These etched light panels 441 may be illuminated by upper edge lights 460 and lower edge lights 465 that are configured to illuminate edge portions of the etched light panels 441. As described above, these etched light panels 441 may include a design or pattern that is visible though the reel glass 420 when the edge lights 460 and 465 are illuminated. The gaming device door 405 may also include upper individual reel light sources 480 and lower individual reel light sources 485. As shown in the embodiment illustrated in FIG. 4A, the upper and lower individual reel light sources 480, 485 may be angled toward the spinning reels 410 to provide better illumination of the spinning reels 410.

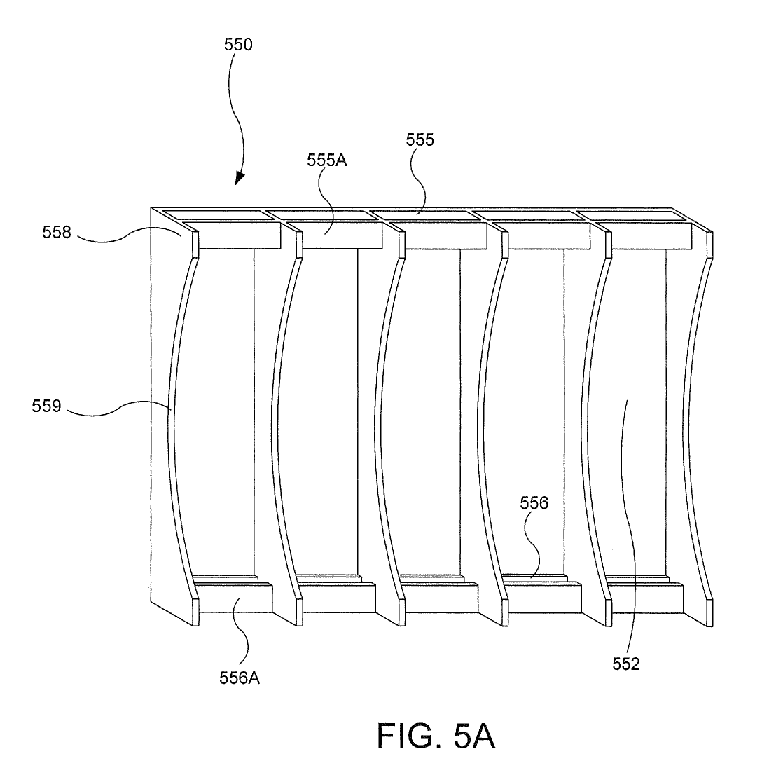

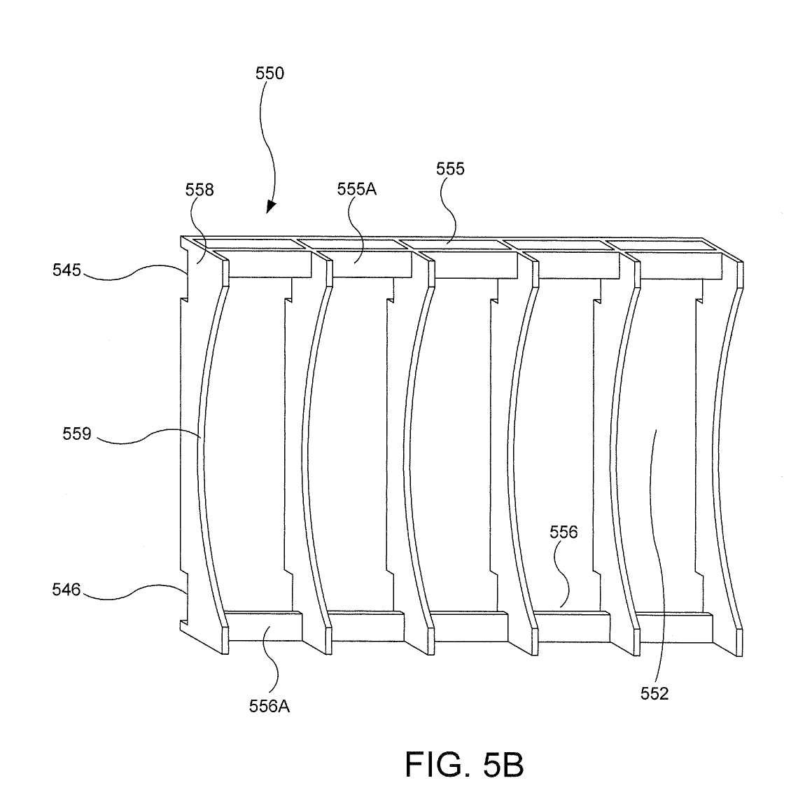

The gaming device door 405 may also include a molded frame 450 to visually separate the spinning reels 410 and keep light from the individual reel light sources directed to only the proper spinning reel 410. That is, the molded frame may be configured to restrict light from an individual reel light source 480 directed at a first spinning reel from partially illuminating parts of an adjacent spinning reel that is not illuminated by its corresponding individual reel light source 480. This feature may provide a cleaner look and eliminate player confusion when the individual reel light sources 480, 485 are illuminating portions of the spinning reels 410. To help accomplish this objective, the molded frame 450 may be configured so that it is positioned between adjacent spinning reels 410. The molded frame 450 may also include openings (see FIG. 5A, for example) to allow the spinning reels 410 to remain visible though the transparent portions 430 of the reel glass. In addition, the molded frame 450 may include openings (see FIG. 5A) that allow the upper and lower individual reel light sources 480, 485 to properly illuminate the spinning reels 410. The molded frame 450 may also include at least one panel slot 445 to fix the etched light panels 441 between the molded frame 450 and the reel glass 420. However, in other embodiments, the etched light panels 441 may not be present. In these embodiments, the edge light sources 460 and 465 may be replaced by fluorescent or LED back lights (not shown) to highlight screened graphics on the upper and lower portions of the reel glass 420. The molded frame 450 may be constructed of one or more of a plastic, a polymer, a metal, or any other material suitable to block light.

FIG. 4B illustrates a side view of the gaming device shown in FIG. 4A with a gaming door in a closed position. Referring to FIG. 4B, when the gaming door 405 is closed against the gaming device 400, the molded frame 450 may be configured to be positioned between adjacent spinning reels 410. This configuration prevents light from an individual reel light source 480, 485 from partially illuminating an adjacent spinning reel 410.

FIG. 4C illustrates a detailed view of section A of the gaming device shown in FIGS. 4A and 4B. In particular, FIG. 4C shows a close up of an embodiment where the edge lights 460 and the individual reel light sources 480 are connected to a common PCB (printed circuit board) 490. The edge lights 460 and individual reel light sources 480 may both be LED light sources. The individual reel light sources 480 may be directly attached to the PCB 480 or may be disposed within the molded frame 450 and electrically connected to the PCB 490 through a wire or other connection means (not shown). The PCB 490 may be mounted to the gaming door 405 through a mounting bracket 495. The molded frame 450 may also be at least partially attached to the gaming door 405 through the mounting bracket 495. Although FIG. 4C shows a detailed view of the upper edge lights 460 and upper individual reel light sources 480 being mounted to a common PCB 490, the lower edge lights 465 and lower individual reel light sources 485 may also be mounted to a separate common PCB (not shown) in a similar manner. The PCB 490 may be electrically connected to a gaming processor (such as processor 52 in FIG. 1A) in the gaming device 400, where the gaming processor controls the illumination timing, color, and intensity of the individual reel light sources 480 and 485.

FIG. 5A illustrates an isometric view of a molded frame according to an embodiment of the present invention. Referring to FIG. 5, the molded frame 550 may include edge portions 558 and middle curved portions 559 to position the molded frame 550 between individual spinning reels so that light from adjacent individual reel light sources may be blocked from illuminating a particular spinning reel. The molded frame 550 may also include a plurality of reel openings 552 positioned between the curved portions 559 of the molded frame to allow the spinning reels to be visible to the player. In the embodiment shown in FIG. 5, five reel openings 552 are present to correspond to five spinning reels being present on a gaming device, as is shown, for example, in FIG. 2. However, in other embodiments fewer reel openings 552 may be present for applications in gaming device that include three, four, etc. spinning reels.

The molded frame 550 may also include a plurality of upper light openings 555 and a plurality of lower light openings 556 to respectively allow the upper and lower individual reel light sources to illuminate corresponding spinning reels. Although not shown in FIG. 5, the inner barriers 555A and 556A of the upper and lower light openings 555 and 556 may be angled toward the spinning reels to further help the individual reel light sources to illuminate the full visible portion of the spinning reels. In other embodiments, the inner barriers 555A and 556A may be omitted.

FIG. 5B illustrates an isometric view of a molded frame according to another embodiment of the present invention. Referring to FIG. 5B, the molded frame 550 illustrated in this embodiment includes an upper panel slot 545 in the upper portion of the molded frame 550 and a lower panel slot 546 in the lower portion of the molded frame 550. The upper panel slot 545 and lower panel slot 546 may be configured to coordinate with the etched light panels 441 shown in FIGS. 4A-4C.

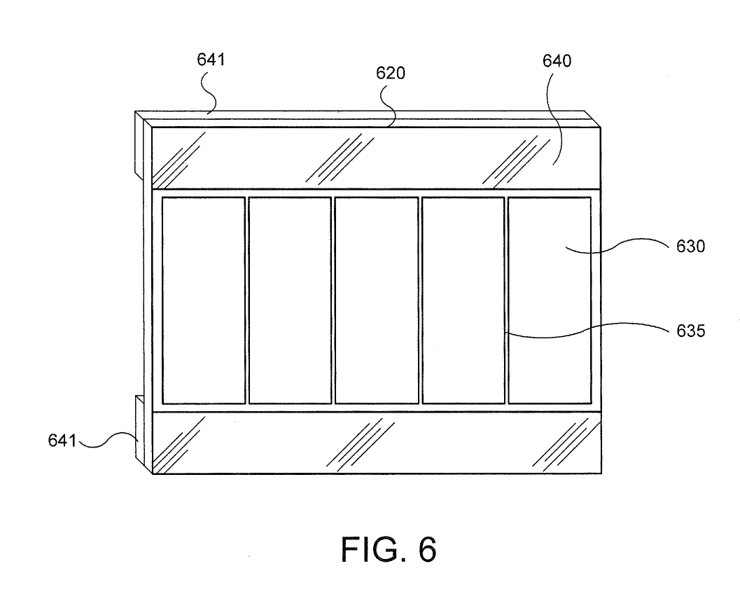

FIG. 6 illustrates a front view of a reel glass according to an embodiment of the present invention. Referring to FIG. 6, reel glass 620 may include substantially opaque header/footer portions 640, substantially transparent reel window portions 630, and substantially opaque reel divider portions 635. In some embodiments, the header/footer portions 640 and reel divider portions 635 may include screened printing on the reel glass 620 as described with reference to FIG. 2. In this embodiment, these portions may be backlit by one or more light sources such as a fluorescent or LED light source. In other embodiments, the header/footer portions 640 may include an etched light-reflective etched acrylic light sheet panel 641, such as the ones manufactured by Hunatech disposed behind these portions 640. In this embodiment, these portions may be edge lit by one or more light sources such as an LED light source. The reel window portions 630 may be configured to provide a clear view of the spinning reels of the gaming device (see FIG. 2, for example).

Having described and illustrated the principles of the invention in embodiments thereof, it should be apparent that the invention can be modified in arrangement and detail without departing from such principles. I claim all modifications and variations coming within the spirit and scope of the following claims.

1. A gaming device comprising:
a plurality of spinnable reels;
a molded frame visually separating the reels, the molded frame including a plurality of light openings;
a plurality of individual light sources corresponding to at least a portion of the plurality of light openings, where each light source is associated with at least of one of the plurality of spinnable reels.

2. The gaming device of claim 1, wherein the plurality of light openings includes a first plurality of light openings in a top surface of the molded frame and a second plurality of light openings in a bottom surface of the molded frame.

3. The gaming device of claim 2, wherein the plurality of individual light sources includes a first plurality of individual light sources corresponding to the first plurality of light openings and a second plurality of individual light sources corresponding to the second plurality of light openings.

4. The gaming device of claim 1, further comprising a plurality of reel back lights disposed behind the plurality of spinnable reels.

5. The gaming device of claim 1, wherein each light opening is associated with at least one of the plurality of individual light sources.

6. The gaming device of claim 5, wherein each light opening is associated with at least two individual light sources configured to display different colored lights.

7. The gaming device of claim 5, wherein each light source includes a light source configured to display multiple light colors.

8. The gaming device of claim 1, wherein each individual light source is an LED.

9. A gaming device comprising:
a plurality of spinnable reels, where a portion of each spinnable reel is visible to a player of the gaming device;
means to separate the visible portions of the spinnable reels; and
means to individually light each of the plurality of spinnable reels, wherein the means to separate the visible portions of the spinnable reels further restricts the means to individually light the visible portions of the spinnable reels to light only a corresponding spinnable reel.

10. The gaming device of claim 9, wherein the means to individually light each of the plurality of spinnable reels includes a plurality of light sources.

11. The gaming device of claim 10, wherein each of the spinnable reels corresponds to at least one of the plurality of light sources.

12. The gaming device of claim 9, further comprising means to back light each of the plurality of spinnable reels.

13. A gaming device including a main door comprising:
a plurality of spinnable reels;
a reel glass panel configured to allow a portion of each spinnable reel to be visible to a player of the gaming device;
a molded frame including a plurality of reel barriers and a plurality of light openings respectively opening between adjacent reel barriers, the reel barriers configured to be positioned between adjacent spinnable reels when the main door is in a closed position; and
a plurality of individual light sources corresponding to the plurality of light openings, wherein the reel barriers of the molded frame restrict light from adjacent individual light sources from lighting the visible portion of a particular spinnable reel.

14. The gaming device of claim 13, wherein the gaming device includes three spinnable reels.

15. The gaming device of claim 13, wherein the gaming device includes four spinnable reels.

16. The gaming device of claim 13, wherein the gaming device includes five spinnable reels.

17. The gaming device of claim 13, further comprising at least one etched light panel disposed between the molded frame and the reel glass.

18. The gaming device of claim 17, further comprising at least one edge light source corresponding to an edge of the etched light panel.

19. The gaming device of claim 17, further comprising at least one printed circuit board disposed above the molded frame, the printed circuit board electrically connected to the at least one edge light source and the plurality of individual light sources.

20. A gaming device comprising:
a plurality of spinnable reels;
a reel glass panel configured to allow a portion of each spinnable reel to be visible to a player of the gaming device;
a molded frame mounted adjacent to the reel glass panel, the molded frame including:
a plurality of reel barriers to visually separate the spinnable reels,
a plurality of upper individual reel light opening formed in an upper portion of the molded frame, and
an upper panel slot;
an upper etched light panel disposed in the upper panel slot of the molded frame and directly adjacent to the reel glass panel; and
an upper printed circuit board disposed above the molded frame, the upper printed circuit board including:
at least one edge light source corresponding to an upper edge of the upper etched light panel, and
a plurality of individual reel light sources corresponding to the plurality of upper individual reel light openings, where each individual reel light source is associated with at least of one of the plurality of spinnable reels.

21. The gaming device of claim 20, wherein the molded frame further includes a lower panel slot and a plurality of lower individual reel light opening formed in a lower portion of the molded frame.

22. The gaming device of claim 21, further comprising:
a lower etched light panel disposed in the lower panel slot of the molded frame and directly adjacent to the reel glass panel; and
a lower printed circuit board disposed below the molded frame, the lower printed circuit board including:
at least one edge light source corresponding to a lower edge of the lower etched light panel, and
a plurality of individual reel light sources corresponding to the plurality of lower individual reel light openings, where each individual reel light source is associated with at least of one of the plurality of spinnable reels.

23. The gaming device of claim 22, further include a plurality of reel back lights, where each spinnable reel corresponds to at least one of the reel back lights.
